(19) United States
(12) Patent Application Publication
(10) Pub. No.: US 2001/0053742 A1
(43) Pub. Date: Dec. 20, 2001

(54) CATALYST AND PROCESSES FOR OLEFIN TRIMERIZATION

(76) Inventors: RONALD D. KNUDSEN, BARTLESVILLE, OK (US); JEFFREY W. FREEMAN, BARTLESVILLE, OK (US)

Correspondence Address: LYNDA S JOLLY, RICHMOND HITCHCOCK FISH & DOLLAR, P O BOX 2443, BARTLESVILLE, OK, 74005

(21) Appl. No.: 09/216,565

(22) Filed: Dec. 18, 1998

(51) Int. Cl. B01J 37/00

(52) U.S. Cl. 502/117; 502/108; 502/118; 502/119; 502/123

(57) ABSTRACT

A process is provided to modify an olefin production catalyst system which comprises contacting an olefin production catalyst system with ethylene prior to use. A second embodiment of the invention comprises contacting an aluminum alkyl and a pyrrole-containing compound prior to contacting a chromium containing compound and prior to contacting an olefin. A process also is provided to trimerize and/or oligomerize olefins with the novel, modified olefin catalyst production systems. These modified olefin production catalyst systems can produce less solids, such as, for example, polymer, during a trimerization reaction.

### BACKGROUND OF THE INVENTION

This invention relates to olefin production and olefin production catalyst systems.

Olefins, primarily alpha-olefins, have many uses. In addition to uses a specific chemicals, alpha olefins, especially mono-1-olefins, can be used in polymerization processes either as monomers or comonomers to prepare polyolefins, or polymers. These alpha-olefins usually are used in a liquid or gas state. Unfortunately, very few efficient processes to selectively produce a specifically desired alpha-olefin are known. Furthermore, catalyst preparation processes to produce catalyst systems for the production of alpha-olefins generally are produced by an exothermic reaction. In order to diffuse heat generated by these exothermic reactions, a preferred method to cool the reaction is to stir the components during the catalyst preparation procedure.

Unfortunately, stirring during catalyst preparation can cause particulates in a catalyst system product which can result in low activity and productivity of the resultant catalyst system, as well as particulates in the desired olefin product. These particulate contaminates also can lower the heat transfer coefficient of the reactor and/or can plug valves and piping downstream of the reactor vessel. Thus, even though stirring during catalyst preparation can diffuse the heat of reaction, stirring results in particulates in the catalyst system and product.

### SUMMARY OF THE INVENTION

Accordingly, it is an object of this invention to provide an improved process for the production of olefin trimerization catalyst systems.

It is another object of this invention to provide an improved process for the production of olefin trimerization catalyst systems wherein the heat generated by the preparation reaction can be controlled by order of addition of the catalyst system components without loss of catalyst system activity or productivity.

It is another object of this invention to provide an improved process for the production of olefin trimerization catalyst systems wherein the heat generated by the preparation reaction can be controlled by stirring without loss of catalyst system activity or productivity.

It is another object of this invention to provide an improved process for the production of olefin trimerization catalyst systems wherein the heat generated by the preparation reaction can be controlled by preparing said catalyst system prior to contacting an olefin reactant without loss of catalyst system activity or productivity.

It is still another object of this invention to provide an improved process for the production of olefin trimerization catalyst systems wherein the heat generated by the preparation reaction can be controlled by preparing said catalyst system in-situ in the presence of the trimerization reactants and using the trimerization reactor to remove the heat of catalyst preparation and subsequent heat of the trimerization reaction.

It is a further object of this invention to provide an improved olefin production catalyst system that maintains high catalyst activity and productivity.

In accordance with this invention, a process is provided to prepare an olefin trimerization catalyst system comprising contacting and stirring a chromium compound, a pyrrole-containing compound, and a non-hydrolyzed aluminum alkyl compound in the presence of an unsaturated hydrocarbon compound prior to contacting an olefin reactant.

In accordance with another embodiment of this invention, a process is provided to prepare an olefin trimerization catalyst system comprising contacting and stirring a pyrrole-containing compound and a non-hydrolyzed aluminum-alkyl in a first step and a second step wherein said resulting aluminum/pyrrole reaction product is contacted with a chromium-containing compound in the presence of a unsaturated hydrocarbon compound prior to contacting an olefin reactant.

### DETAILED DESCRIPTION OF THE INVENTION

### Catalyst Systems

Catalyst systems useful in accordance with this invention comprise a chromium source, a pyrrole-containing compound and a metal alkyl, all of which have been contacted and/or reacted in the presence of an unsaturated hydrocarbon. Optionally, these catalyst systems can be supported on an inorganic oxide support. These catalyst systems are especially useful for the dimerization and trimerization of olefins, such as, for example, ethylene to 1-hexene. Unless otherwise stated, the preferred catalyst system of this invention is a homogeneous catalyst system. Optionally, known catalyst system supports can be used to produce heterogeneous catalyst systems. It should be noted that the catalyst system is both air and water sensitive. All work with catalyst systems should be done under inert atmosphere conditions, such as nitrogen, using anhydrous, degassed solvents.

The chromium source can be one or more organic or inorganic compounds, wherein the chromium oxidation state is from 0 to 6. Generally, the chromium source will have a formula of CrXₙ, wherein X can be the same or different and can be any organic or inorganic radical, and n is an integer from 1 to 6. Exemplary organic radicals can have from about 1 to about 20 carbon atoms per radical, and are selected from the group consisting of alkyl, alkoxy, ester, ketone, and/or amido radicals. The organic radicals can be straight-chained or branched, cyclic or acyclic, aromatic or aliphatic, can be made of mixed aliphatic, aromatic, and/or cycloaliphatic groups. Exemplary inorganic radicals include, but are not limited to halides, sulfates, and/or oxides.

Preferably, the chromium source is a chromium(II)- and/or chromium(III)-containing compound which can yield a catalyst system with improved trimerization or oligomerization activity. Most preferably, the chromium source is a chromium(III) compound because of ease of use, availability, and enhanced catalyst system activity. Exemplary chromium(III) compounds include, but are not limited to, chromium carboxylates, chromium naphthenates, chromium halides, chromium pyrrolides, and/or chromium dionates. Specific exemplary chromium(III) compounds include, but are not limited to, chromium(III) 2,2,6,6,-tetramethylheptanedionate [Cr(TMHD)], chromium(III) 2-ethylhexanoate [Cr(EH) or chromium(III) tris(2-ethylhexanoate),] chromium(III) naphthenate [Cr(Np)], chromium(III) chloride, chromic bromide, chromic fluoride, chromium(III) acetylacetonate, chromium(III) acetate, chromium(III) butyrate, chromium(III) neopentanoate, chromium(III) laurate, chromium(III) stearate, chromium (III) pyrrolides and/or chromium(III) oxalate.

Specific exemplary chromium(II) compounds include, but are not limited to, chromous bromide, chromous fluoride, chromous chloride, chromium(II) bis(2-ethylhexanoate), chromium(II) acetate, chromium(II) butyrate, chromium(II) neopentanoate, chromium(II) laurate, chromium(II) stearate, chromium(II) oxalate and/or chromium(II) pyrrolides.

The pyrrole-containing compound can be any pyrrole-containing compound, or pyrrolide, that will react with a chromium source to form a chromium pyrrolide complex. As used in this disclosure, the term “pyrrole-containing compound” refers to hydrogen pyrrolide, i.e., pyrrole (C₅H₅N), derivatives of hydrogen pyrrolide, substituted pyrrolides, as well as metal pyrrolide complexes. A “pyrrolide” is defined as a compound comprising a 5-membered, nitrogen-containing heterocycle, such as for example, pyrrole, derivatives of pyrrole, and mixtures thereof. Broadly, the pyrrole-containing compound can be pyrrole and/or any heteroleptic or homoleptic metal complex or salt, containing a pyrrolide radical, or ligand. The pyrrole-containing compound can be either affirmatively added to the reaction, or generated in-situ.

Generally, the pyrrole-containing compound will have from about 4 to about 20 carbon atoms per molecule. Exemplary pyrrolides are selected from the group consisting of hydrogen pyrrolide (pyrrole), lithium pyrrolide, sodium pyrrolide, potassium pyrrolide, cesium pyrrolide, aluminum pyrrolide, and/or the salts of substituted pyrrolides, because of high reactivity and activity with the other reactants. Examples of substituted pyrrolides include, but are not limited to, pyrrole-2-carboxylic acid, 2-acetylpyrrole, pyrrole-2-carboxaldehyde, tetrahydroindole, 2,5-dimethylpyrrole, 2,4-dimethyl-3-ethylpyrrole, 3-acetyl-2,4-dimethylpyrrole, ethyl-2,4-dimethyl-5-(ethoxycarbonyl)-3-pyrrole-proprionate, ethyl-3,5-dimethyl-2-pyrrolecarboxylate, and mixtures thereof. When the pyrrole-containing compound contains chromium, the resultant chromium compound can be called a chromium pyrrolide.

The most preferred pyrrole-containing compounds used in a trimerization catalyst system are selected from the group consisting of hydrogen pyrrolide, i.e., pyrrole (C₅H₅N), 2,5-dimethylpyrrole and/or chromium pyrrolides because of enhanced trimerization activity. Optionally, for ease of use, a chromium pyrrolide can provide both the chromium source and the pyrrole-containing compound. As used in this disclosure, when a chromium pyrrolide is used to form a catalyst system, a chromium pyrrolide is considered to provide both the chromium source and the pyrrole-containing compound. While all pyrrole-containing compounds can produce catalyst systems with high activity and productivity, use of pyrrole and/or 2,5-dimethylpyrrole can produce a catalyst system with enhanced activity and selectivity to a desired product.

The metal alkyl can be any heteroleptic or homoleptic metal alkyl compound. One or more metal alkyl compounds can be used. The alkyl ligand(s) on the metal can be aliphatic and/or aromatic. Preferably, the alkyl ligand(s) are any saturated or unsaturated aliphatic radical. The metal alkyl can have any number of carbon atoms. However, due to commercial availability and ease of use, the metal alkyl will usually comprise less than about 70 carbon atoms per metal alkyl molecule and preferably less than about 20 carbon atoms per molecule. Exemplary metal alkyls include, but are not limited to, alkylaluminum compounds, alkylboron compounds, alkylmagnesium compounds, alkylzinc compounds and/or alkyl lithium compounds. Exemplary metal alkyls include, but are not limited to, n-butyl lithium, s-butyllithium, t-butyllithium, diethylmagnesium, diethylzinc, triethylaluminum, trimethylaluminum, triisobutylalumium, and mixtures thereof.

Preferably, the metal alkyl is selected from the group consisting of non-hydrolyzed, i.e., not pre-contacted with water, alkylaluminum compounds, derivatives of alkylaluminum compounds, halogenated alkylaluminum compounds, and mixtures thereof for improved product selectivity, as well as improved catalyst system reactivity, activity, and/or productivity. The use of hydrolyzed metal alkyls can result is decreased olefin, i.e., liquids, production and increased polymer, i.e., solids, production.

Most preferably, the metal alkyl is a non-hydrolyzed alkylaluminum compound, expressed by the general formulae AlR₃, AlR₂X, AlRX₂, AlR₂(OR), and/or AlRX(OR), wherein R is an alkyl group and X is a halogen atom. Exemplary compounds include, but are not limited to, triethylaluminum, tripropylaluminum, tributylaluminum, diethylaluminum chloride, diethylaluminum bromide, diethylaluminum ethoxide, diethylaluminum phenoxide, ethylaluminum dichloride, ethylaluminum sesquichloride, and mixtures thereof for best catalyst system activity and product selectivity. The most preferred alkylaluminum compound is triethylaluminum, for best results in catalyst system activity and product selectivity.

Catalyst system components can be contacted under any conditions in order to affect preparation of an effective trimerization catalyst system. Preferably, temperature range when the components are contacted is within a range of about −78° C. to about 200° C., preferably within a range of about 0° C. to about 50° C. Most preferably, catalyst preparation temperatures are kept within a range of 10° C. to 40° C. in order to minimize particulate formation and maximize catalyst system activity and productivity. All catalyst system preparation and all trimerization is done under an inert atmosphere, such as for example nitrogen or argon. The preferred inert atmosphere is nitrogen due to ease of use and availability. Pressure during catalyst system preparation can be any pressure in order to affect catalyst system preparation. Preferably, ambient pressures are used.

The unsaturated hydrocarbon can be any aromatic or aliphatic hydrocarbon, in a gas, liquid or solid state. Preferably, to effect thorough contacting of the inorganic oxide and metal alkyl, the unsaturated hydrocarbon will be in a liquid state. Further, the unsaturated hydrocarbon will not have any halides due to reaction separation difficulties and health and safety concerns. The unsaturated hydrocarbon can have any number of carbon atoms per molecule. Usually, the unsaturated hydrocarbon will comprise less than about 70 carbon atoms per molecule, and preferably, less than about 20 carbon atoms per molecule, due to commercial availability and ease of use. Exemplary unsaturated, aliphatic hydrocarbon atoms include, but are not limited to, ethylene, 1-hexene, 1,3-butadiene, and mixtures thereof. Exemplary unsaturated, aromatic hydrocarbons include, but are not limited to, toluene, benzene, ethylbenzene, xylene, mesitylene, hexamethylbenzene, and mixtures thereof. Unsaturated, aromatic hydrocarbons are preferred in order to improve catalyst system stability, as well as produce a highly active catalyst system in terms of activity and selectivity. Preferred unsaturated aromatic hydrocarbons are selected from the group consisting of toluene, ethylbenzene and mixtures thereof for best resultant catalyst system stability and activity. The most preferred hydrocarbon diluent is ethylbenzene due to ease of separation from reaction diluent(s) and reaction product(s).

### Reactants

Trimerization, as used in this disclosure, is defined as the combination of any two, three, or more olefins, wherein the number of olefin, i.e., carbon-carbon double bonds is reduced by two. Reactants applicable for use in the trimerization process of this invention are olefinic compounds which can a) self-react, i.e., trimerize, to give useful products such as, for example, the self reaction of ethylene can give 1-hexene and the self-reaction of 1,3-butadiene can give 1,5-cyclooctadiene; and/or b) olefinic compounds which can react with other olefinic compounds, i.e., co-trimerize, to give useful products such as, for example, co-trimerization of ethylene plus hexene can give 1-decene or mixed decenes and/or 1-tetradecene or mixed tetradecenes, co-trimerization of ethylene and 1-butene can give 1-octene, co-trimerization of 1-decene and ethylene can give 1-tetradecene and/or 1-docosene. For example, the number of olefin bonds in the combination of three ethylene units is reduced by two, to one olefin bond, in 1-hexene. In another example, the number of olefin bonds in the combination of two 1,3-butadiene units, is reduced by two, to two olefin bonds in 1,5-cyclooctadiene. As used herein, the term “trimerization” is intended to include dimerization of diolefins, as well as “co-trimerization”, both as defined above.

Suitable trimerizable olefin compounds are those compounds having from about 2 to about 30 carbon atoms per molecule and having at least one olefinic double bond. Exemplary mono-1-olefin compounds include, but are not limited to acyclic and cyclic olefins such as, for example, ethylene, propylene, 1-butene, 2-butene, isobutylene, 1-pentene, 2-pentene, 1-hexene, 2-hexene, 3-hexene, 1-heptene, 2-heptene, 3-heptene, the four normal octenes, the four normal nonenes, and mixtures of any two or more thereof. Exemplary diolefin compounds include, but are not limited to, 1,3-butadiene, 1,4-pentadiene, and 1,5-hexadiene. If branched and/or cyclic olefins are used as reactants, while not wishing to be bound by theory, it is believed that steric hindrance could hinder the trimerization process. Therefore, the branched and/or cyclic portion(s) of the olefin preferably should be distant from the carbon-carbon double bond.

Catalyst systems produced in accordance with this invention preferably are employed as trimerization catalyst systems.

### Reaction Conditions

The reaction products, i.e., olefin trimers as defined in this specification, can be prepared from the catalyst systems of this invention by solution reaction, slurry reaction, and/or gas phase reaction techniques using conventional equipment and contacting processes. Contacting of the monomer or monomers with a catalyst system can be effected by any manner known in the art. One convenient method is to suspend the catalyst system in an organic medium and to agitate the mixture to maintain the catalyst system in solution throughout the trimerization process. Other known contacting methods can also be employed.

Reaction temperatures and pressures can be any temperature and pressure which can trimerize the olefin reactants. Generally, reaction temperatures are within a range of about 0° to about 250° C. Preferably, reaction temperatures within a range of about 60° to about 200° C. and most preferably, within a range of 80° to 150° C. are employed. Generally, reaction pressures are within a range of about atmospheric to about 2500 psig. Preferably, reaction pressures within a range of about atmospheric to about 1000 psig and most preferably, within a range of 300 to 800 psig are employed.

Too low of a reaction temperature can produce too much undesirable insoluble product, such as, for example, polymer, and too high of a temperature can cause decomposition of the catalyst system and reaction products. Too low of a reaction pressure can result in low catalyst system activity.

Optionally, hydrogen can be added to the reactor to accelerate the reaction and/or increase catalyst system activity.

Catalyst systems of this invention are particularly suitable for use in trimerization processes. The slurry process is generally carried out in an inert diluent (medium), such as a paraffin, cycloparaffin, or aromatic hydrocarbon. Exemplary reactor diluents include, but are not limited to, isobutane, cyclohexane and 1-hexene. Isobutane can be used to improve process compatibility with other known olefin production processes. However, a homogenous trimerization catalyst system reaction products are more soluble in cyclohexane or methylcyclohexane. Therefore, preferred diluents for homogeneous catalyzed trimerization processes are cyclohexane, methylcyclohexane and mixtures thereof. If 1-hexene, a possible trimerization product, is used as the reactor diluent, then separation of 1-hexene (reaction product) from the diluent (1-hexene) is unnecessary. When the reactant is predominately ethylene, a temperature in the range of about 0° to about 300° C. generally can be used. Preferably, when the reactant is predominately ethylene, a temperature in the range of about 60° to about 130° C. is employed.

### Products

The olefinic products of this invention have established utility in a wide variety of applications, such as, for example, as monomers for use in the preparation of homopolymers, copolymers, and/or terpolymers.

The further understanding of the present invention and its advantages will be provided by reference to the following examples.

### EXAMPLES

As stated earlier, catalyst systems of this invention are both air and water sensitive. All work should be done under inert atmosphere conditions, i.e., nitrogen, using anhydrous, degassed solvents.

Unless otherwise disclosed, trimerization of ethylene to 1-hexene was carried out in a 1-gallon continuous feed autoclave reactor. Cyclohexane was used as the process solvent, or diluent, and the reactor temperature was 115° C. in all runs. Reactor pressure was 800 psig in all runs. Chromium solution was fed at a rate of 30 ml/hour; the aluminum/pyrrole mixture “solvent” was fed at a rate of 1.17 gallons/hour. Each run lasted six (6) hours. At the end of each run, the reactor was opened and any polyethylene polymer that formed was collected, dried and weighed. The liquid product was collected and analyzed.

### Example 1

This example shows the effect of order of addition of catalyst system components during catalyst system preparation.

In general, catalyst systems were prepared by making an aluminum-pyrrole solution by mixing together 0.66 ml of 2,5-dimethylpyrrole (2,5-DMP) and 2.8 ml triethylaluminum (TEA) in 50 ml cyclohexane. A 3.2 ml portion of diethylaluminum chloride (DEAC) was added and the resulting solution was charged to a feed-tank containing 65 lbs of cyclohexane. This solution was used as the reactor solvent for a continuous reactor. A chromium solution was prepared by dissolving 0.20 g of chromium (III) 2-ethylhexanoate (Cr(EH)₃) into 250 ml cyclohexane. This solution was charged to the catalyst holding vessel for the continuous reactor.

In Runs 101-106, reactor residence time was 0.42 hours (about 25 minutes), ethylene was fed at rate of 1426 grams/hour, hydrogen was fed at a rate of 5.2 liters per hour, and reactor pressure was 800 psig. The molar ratios of Runs 101-105 for Cr/2,5-DMP/TEA/DEAC was 1/16/50/63; the molar ratio for Run 106 was 1/3/11/8. Catalyst system concentration for Runs 101-105 was 0.082 mg/ml; for Run 106 was 0.16 mg/ml. The results are given below in Table 1.

Run 101

Catalyst system was prepared as described above and reactor conditions were as described above.

Run 102

The same procedure used in Run 101 was followed except that the DEAC and the TEA were mixed together and then added to the 2,5-DMP.

Run 103

The same procedure used in Run 101 was followed except that the DEAC and 2,5-DMP were mixed together and then added to the TEA in the feed tank.

Run 104

The procedure described in Run 103 was followed except that the aluminum-2,5-DMP solution was allowed to set for three days prior to use.

Run 105

The same procedure described in Run 103 was followed except that the aluminum-2,5-DMP solution was allowed to set for 28 days prior to use.

Run 106

The same procedure described in Run 101 was followed except that the amount of 2,5-DMP with 0.24 ml, TEA was 1.2 ml, DEAC was 0.80 ml and Cr(EH)₃ was 0.38 g.

TABLE 1

| | Productivity, | | | | C₆═, | C₆═ | | | |
|---|---|---|---|---|---|---|---|---|---|
| | g olefins/g | % C₂═ | Total Polymer | C₄═, | Total, | Purity | 1-C₆═, | C₈═, | C₁₀═, |
| Run | Cr/hr | conversion | collected, g | wt % | wt % | (1-C₆═/C₆═) | wt %^{(a)} | wt % | wt % |
| 101 | 219,000 | 39.0 | 1.27 | 0.10 | 96.89 | 99.58 | 96.48 | 0.33 | 2.69 |
| 102 | 249,000 | 44.5 | 1.24 | 0.10 | 96.79 | 99.56 | 96.37 | 0.33 | 2.77 |
| 103 | 262,000 | 46.9 | 1.52 | 0.07 | 96.67 | 99.56 | 96.24 | 0.36 | 2.89 |
| 104 | 253,000 | 45.5 | 0.44 | 0.10 | 96.11 | 99.46 | 95.59 | 0.34 | 3.44 |
| 105 | 252,000 | 45.2 | 1.50 | 0.10 | 96.37 | 99.49 | 95.88 | 0.35 | 3.17 |
| 106 | 167,000 | 61.1 | 9.52 | 0.08 | 94.87 | 99.40 | 94.30 | 0.36 | 4.58 |

^{(a)}Weight percent of 1-C₆═ (1-hexene) is based on the total weight of all hexenes collected.

The data in Table 1 show that the order of addition, either first combining the aluminum alkyl compounds and then contacting the pyrrole-containing compound or first adding the pyrrole-containing compound to one of the aluminum alkyl compounds and then adding another aluminum alkyl compound does not effect catalyst system activity or productivity. The data also show that preparing the catalyst system with stirring prior to contacting ethylene can diffuse the heat generated by the catalyst system preparation. Analysis of the data for Runs 104 and 105 show that the aluminum/pyrrole solution has a long shelf life and pre-mixing the aluminum compounds and pyrrole-containing compound does not have a negative effect on catalyst system activity or productivity.

### Example 2

This example shows the effect of stirring during catalyst system preparation.

Run 201

201.7 grams of chromium tris(2-ethylhexanoate) (Cr(EH)₃) was dissolved in 1000 ml of toluene. This solution was charged to a 5 gallon reactor containing 13.7 lbs of toluene. Then, 125 ml of 2,5-dimethylpyrrole (2,5-DMP) was added to the chromium solution. The reactor was closed, the stirrer turned on, and the system was purged with nitrogen for 5 minutes (to remove any residual air). Next, 516 g of triethyl aluminum (TEA) and 396 g of diethylaluminum chloride (DEAC) were combined in a mix tank. The resulting aluminum alkyl mixture then was pressured into the 5 gallon reactor. Cooling water to the reactor was turned on and the contents of the reactor were stirred for one hour. While not wishing to be bound by theory, it is believed that the catalyst system can form within about five to about ten minutes of contacting all components.

After one hour, stirring was stopped and the solution was allowed to gravimetrically settle overnight before filtration. The catalyst system solution was filtered through a celite and glass wool filter into a 5 gallon storage tank. A sample of the resultant, homogeneous catalyst system was visually inspected in a glove box and then tested under trimerization conditions.

Run 202

The same procedure provided in Run 201 was followed except that a nitrogen purge was used to mix the reactor contents instead of a mechanical stirrer.

Run 203

The same procedure provided in Run 201 was followed except that reactor contents were not stirred during the reaction.

Run 204

630.9 grams of Cr(EH)₃ was dissolved in 1000 ml of ethylbenzene. This solution was charged to a 5 gallon reactor containing 17.9 lbs of ethylbenzene. Then, 233 ml of 2,5-DMP was added to the chromium solution. The reactor was closed, the stirrer turned on, and the system was purged with nitrogen for 5 minutes (to remove any residual air). Next, 953 g of TEA and 775 g of DEAC were combined in a mix tank. The resulting aluminum alkyl mixture then was pressured into the 5 gallon reactor. Cooling water to the reactor was turned on and the contents of the reactor were stirred for one hour. While not wishing to be bound by theory, it is believed that the catalyst system can form within about five to about ten minutes of contacting all components.

After one hour, stirring was stopped and the solution was allowed to gravimetrically settle for overnight before filtration. The catalyst system solution was filtered through a celite and glass wool filter into a 5 gallon storage tank. A sample of the resultant, homogeneous catalyst system was visually inspected in a glove box and then tested under trimerization conditions.

Run 205 The same procedure provided in Run 4 was followed except that the reactor contents were not stirred during the reaction.

Run 206

630.9 grams of Cr(EH)₃ was dissolved in 1000 ml of toluene. This solution was charged to a 5 gallon reactor containing 15.1 lbs of toluene. Then, 388 ml of 2,5-DMP was added to the chromium solution. The reactor was closed, the stirrer turned on, and the system was purged with nitrogen for 5 minutes (to remove any residual air). Next, 1600 g of TEA and 1229 g of DEAC were combined in a mix tank. The resulting aluminum alkyl mixture then was pressured into the 5 gallon reactor. The cooling water to the reactor was turned on and the contents of the reactor were not stirred. The cooling water was turned off when the reactor temperature reached 25° C. While not wishing to be bound by theory, it is believed that the catalyst system can form within about five to about ten minutes of contacting all components.

The solution was allowed to gravimetrically settle overnight before filtration. The catalyst system solution was filtered through a celite and glass wool filter into a 5 gallon storage tank. A sample of the resultant, homogeneous catalyst system was visually inspected in a glove box and then tested under trimerization conditions.

Run 207

The same procedure given in Run 206 was used except ethylbenzene was used in place of toluene.

Run 208

A chromium solution was prepared by dissolving a 630.9 g portion of Cr(EH)₃ in 1000 ml of ethylbenzene and the resulting solution was placed into a holding tank. A 5 gallon reactor was charged with 14.1 pounds of ethylbenzene. A 388 ml of portion of 2,5-DMP then was added to the reactor. The reactor was closed, the stirrer turned on, and the system purged with nitrogen for 5 minutes to remove and residual air. Cooling water to the reactor was turned on. Then 1600 g of TEA and 1229 g of DEAC were added to the mix tank. The resulting aluminum alkyl mixture was then pressurized into the 5 gallon reactor and the maximum temperature recorded. An additional 0.2 lbs of ethylbenzene was added to the reactor in order to flush out the line.

When the reactor temperature had cooled to 25° C., the stirrer was turned off. After about 15 minutes, the chromium solution was pressured into the reactor. An additional 1 lb of ethylbenzene was added to flush out the lines. The solution was allowed to settle overnight and filtered through a filter containing celite and glass wool into a 5 gallon storage tank. A sample of the catalyst was taken into a glove box for visual inspection and testing.

Run 209

A chromium solution was prepared as described in Run 208. As described in run 208, a 5 gallon reactor was charged with 14.1 lbs of ethylbenzene. A 388 ml portion of 2,5-DMP was added to the reactor. The reactor was closed and the system purged with nitrogen for 5 minutes to remove any residual air. Cooling water to the reactor was turned on and the stirrer set at 100 rpm. Next 1600 g of TEA and 1229 g of DEAC were added to the mix tank. The resulting aluminum alkyl mixture was then pressured into the 5 gallon reactor and the maximum temperature recorded. An additional 0.2 lbs of ethylbenzene was added to the reactor in order to flush out the lines.

When the reactor temperature had cooled to 25° C., the chromium solution was pressured into the reactor. An additional 1 lb of ethylbenzene was added to flush out the lines. The maximum temperature was recorded and the solution stirred for 15 minutes. The solution was allowed to settle overnight and then filtered through a filter containing celite and glass wool into a 5 gallon storage tank. A sample of the catalyst was taken into a glove box for visual inspection and testing.

Run 210

The same procedure provided in Run 209 was followed except that the stir rate was 400 rpm.

Run 211

The same procedure given in Run 209 was used except the stir rate was 700 rpm.

Run 212

The same procedure given in Run 209 was used except the stir rate was 1000 rpm.

The catalyst system is both air and water sensitive. All work should be done under inert atmosphere conditions (nitrogen) using anhydrous, degassed solvents. Trimerization of ethylene to 1-hexene was carried out in a 1-gallon continuous feed autoclave reactor with the exception of Run 212, which used a 1-liter autoclave reactor. Cyclohexane was used as the process solvent, or diluent, and the reactor temperature was 115° C. for all runs. Catalyst was fed at a rate of 30 ml/hour and each run lasted 6 hours. At the end of each run, the reactor was opened and any polyethylene that formed was collected, dried and weighed. Catalyst system preparation observations are given in Table 2. Reactor conditions for each run are given in Table 3. Analyses of the product is given in Table 4.

TABLE 2

| | | | | Catalyst Preparation |
|---|---|---|---|---|
| Run | Addition Order | Stirring | | Solution Clarity |
| 201 | Cr/DMP^{(a)} + AL | 400 | rpm | black suspension; |
| | | | | could not filter out |
| 202 | Cr/DMP + Al | nitrogen | | black suspension; |
| | | purge | | could not filter out |
| 203 | Cr/DMP + Al | none | | clear orange |
| 204 | Cr/DMP + Al | 400 | rpm | black suspension; |
| | | | | could not filter out |
| 205 | Cr/DMP + Al | none | | clear orange |
| 206 | Cr/DMP + Al | none | | clcar orange |
| 207 | Cr/DMP + Al | none | | clear orange |
| 208 | Cr + Al/DMP | none | | clear orange |
| 209 | Cr + Al/DMP | 100 | rpm | clear orange |
| 210 | Cr + Al/DMP | 400 | rpm | clear orange |
| 211 | Cr + Al/DMP | 700 | rpm | clear orange |
| 212 | Cr + Al/DMP | 1000 | rpm | clear orange |

^{(a)}DMP is 2,5-dimethylpyrrole

TABLE 3
Reactor Conditions

| | | | | | | Catalyst |
|---|---|---|---|---|---|---|
| | Residence | | Solvent, | | Pres- | Concen- |
| Ex- | time, | Ethylene, | gallons/ | Hydrogen, | sure, | tration |
| ample | hours | grams/hr | hr | liters/hr | psia | mg/ml |
| 201 | 0.61 | 1960 | 0.47 | 19.6 | 1450 | 0.5 |
| 202 | 0.61 | 1960 | 0.47 | 19.6 | 1450 | 0.5 |
| 203 | 0.61 | 1960 | 0.47 | 19.6 | 1450 | 0.5 |
| 204 | 0.42 | 1430 | 1.17 | 5.2 | 800 | 0.8 |
| 205 | 0.42 | 1430 | 1.17 | 5.2 | 800 | 0.8 |
| 206 | 0.42 | 1430 | 1.17 | 5.2 | 800 | 0.8 |
| 207 | 0.42 | 1430 | 1.17 | 5.2 | 800 | 0.8 |
| 208 | 0.42 | 1430 | 1.17 | 5.2 | 800 | 0.8 |
| 209 | 0.42 | 1430 | 1.17 | 5.2 | 800 | 0.8 |
| 210 | 0.42 | 1430 | 1.17 | 5.2 | 800 | 0.8 |
| 211 | 0.42 | 1430 | 1.17 | 5.2 | 800 | 0.8 |
| 212 | 0.42 | 376 | 0.31 | 1.4 | 800 | 0.8 |

TABLE 4
Analytical Results

| | | | Internal | | | | Ethylene | | Total Polymer |
|---|---|---|---|---|---|---|---|---|---|
| | Butenes, | 1-Hexene, | Hexenes, | Octenes, | Decenes, | | Conversion, | Productivity, | Collected, |
| Run | wt % | wt % | wt % | wt % | wt % | % Heavier | % | g olefins/g Cr | g |
| 201 | 0.48 | 93.69 | 0.75 | 0.45 | 4.48 | 0.16 | 58.1 | 71400 | 1.72 |
| 202 | 0.17 | 93.08 | 0.75 | 0.32 | 5.38 | 0.29 | 77.6 | 94700 | 1.42 |
| 203 | 0.44 | 87.76 | 1.02 | 0.38 | 9.55 | 0.85 | 80.7 | 92800 | 0.92 |
| 204 | 0.11 | 81.88 | 0.62 | 0.03 | 16.09 | 1.26 | 84.9 | 41200 | 1.77 |
| 205 | 0.11 | 84.54 | 0.71 | 0.25 | 13.30 | 1.09 | 86.6 | 43400 | 2.36 |
| 206 | 0.20 | 88.36 | 1.07 | 0.22 | 9.54 | 0.61 | 82.5 | 43200 | 0.62 |
| 207 | 0.28 | 89.01 | 1.18 | 0.28 | 8.56 | 0.70 | 83.5 | 44000 | 0.69 |
| 208 | 0.16 | 84.74 | 0.88 | 0.24 | 12.82 | 1.19 | 86.0 | 43200 | 2.16 |
| 209 | 0.14 | 82.76 | 1.06 | 0.27 | 14.41 | 1.35 | 86.5 | 42400 | 0.58 |
| 210 | 0.14 | 83.79 | 1.02 | 0.28 | 13.54 | 1.24 | 86.0 | 42700 | 0.21 |
| 211 | 0.16 | 82.79 | 0.99 | 0.30 | 14.37 | 1.39 | 87.5 | 43000 | 0.76 |
| 212 | 0.15 | 84.62 | 0.96 | 0.27 | 12.60 | 1.39 | 87.5 | 43800 | 0.29 |

The data in Table 2, in Runs 201-207, show that the absence of stirring results in a homogeneous catalyst system that does not have any solids, nor any suspended particulates. When the catalyst system is stirred during preparation, solids are produced and a black, particulate suspension is formed.

The data in Table 2 show that mechanical stirring results, not only in production of solid particulates, as shown in Table 2, but also higher production of undesirable polymer products. Nitrogen purging, which is a less aggressive mixing technique than mechanical stirring, also results in polymer production and formation, but less than under conditions of mechanical stirring. When no external processes are used for stirring, polymer production significantly decreases. Run 5 is an anomaly and it is believed that impurities were present in the cyclohexane trimerization process solvent, thus accounting for the high production of polymer during trimerization.

The data in Tables 3 and 4, and in Runs 208-212, show that contacting a non-hydrolyzed aluminum alkyl and a pyrrole-containing compound prior to contacting a chromium containing compound can produce a catalyst system that yields consistently higher ethylene conversion and decreased solids (polymer) production. Thus, in order to better control the heat of the reaction generated by the catalyst preparation procedure, stirring can be used if the order of addition of catalyst system components is as disclosed and claimed in this invention. The aluminum alkyl compound(s) and the pyrrole-containing compound first must be contacted and then the chromium-containing compound is added. Finally, this catalyst system can be added to the olefin reactant to trimerize the olefin reactant. This specific order of addition further results in little or no detrimental black precipitate.

While this invention has been described in detail for the purpose of illustration, it is not to be construed as limited thereby but is intended to cover all changes and modifications within the spirit and scope thereof.

That which is claimed is:

1. A process to prepare an olefin production catalyst system comprising contacting a chromium source, a pyrrole-containing compound and a metal alkyl prior to contacting an olefin reactant.

2. A process according to claim 1 wherein said chromium source is selected from the group consisting of chromium(II)-containing compound, a chromium(III)-containing compound, and mixtures thereof.

3. A process according to claim 2 wherein said chromium source is a chromium(III)-containing compound selected from the group selected of chromium carboxylates, chromium naphthenates, chromium halides, chromium pyrrolides, chromium dionates and mixtures of two or more thereof.

4. A process according to claim 3 wherein chromium source is selected from the group consisting of chromium(III) 2,2,6,6,-tetramethylheptanedionate [Cr(TMHD)], chromium(III) 2-ethylhexanoate [Cr(EH) or chromium(III) tris(2-ethylhexanoate),] chromium(III) naphthenate [Cr(Np)], chromium(III) chloride, chromic bromide, chromic fluoride, chromium(III) acetylacetonate, chromium(III) acetate, chromium(III) butyrate, chromium(III) neopentanoate, chromium(III) laurate, and mixtures of two or more thereof. chromium(III) stearate, chromium (III) pyrrolides and/or chromium(III) oxalate.

5. A process according to claim 1 wherein said metal alkyl is a non-hydrolyzed metal alkyl and is selected from the group consisting of alkyl aluminum compounds, alkyl boron compounds, alkyl magnesium compounds, alkyl zinc compounds, alkyl lithium compounds, and mixtures of two or more thereof.

6. A process according to claim 5 wherein said non-hydrolyzed metal alkyl is an alkyl aluminum compound.

7. A process according to claim 6 wherein said alkyl aluminum compound is triethyl aluminum.

8. A process according to claim 1 wherein said pyrrole-containing compound is selected from the group consisting of pyrrole, derivatives of pyrrole, alkali metal pyrrolides, salts of alkali metal pyrrolides, and mixtures thereof.

9. A process according to claim 8 wherein said pyrrole-containing compound is selected from the group consisting of hydrogen pyrrolide, 2,5-dimethylpyrrole, and mixtures thereof.

10. A process according to claim 1 wherein said catalyst system further comprises a halide source.

11. A process according to claim 1 wherein said contacting occurs in the presence of an aromatic compound.

12. A process according to claim 11 wherein said aromatic hydrocarbon has less than about 70 carbon atoms per molecule.

13. A process to prepare an olefin production catalyst system comprising the steps of:
a) contacting a pyrrole-containing compound and a metal alkyl to produce a metal alkyl/pyrrole-containing complex;
b) contacting said metal alkyl/pyrrole-containing complex with a chromium-containing compound;
wherein steps a) and b) occur prior to contacting an olefin reactant.

14. A process according to claim 13 wherein said chromium source is selected from the group consisting of chromium(II)-containing compound, a chromium(III)-containing compound, and mixtures thereof.

15. A process according to claim 14 wherein said chromium source is a chromium(III)-containing compound selected from the group selected of chromium carboxylates, chromium naphthenates, chromium halides, chromium pyrrolides, chromium dionates and mixtures of two or more thereof.

16. A process according to claim 15 wherein chromium source is selected from the group consisting of chromium(III) 2,2,6,6,-tetramethylheptanedionate [Cr(TMHD)], chromium(III) 2-ethylhexanoate [Cr(EH) or chromium(III) tris(2-ethylhexanoate),] chromium(III) naphthenate [Cr(Np)], chromium(III) chloride, chromic bromide, chromic fluoride, chromium(III) acetylacetonate, chromium(III) acetate, chromium(III) butyrate, chromium(III) neopentanoate, chromium(III) laurate, and mixtures of two or more thereof. chromium(III) stearate, chromium (III) pyrrolides and/or chromium(III) oxalate.

17. A process according to claim 13 wherein said metal alkyl is a non-hydrolyzed metal alkyl and is selected from the group consisting of alkyl aluminum compounds, alkyl boron compounds, alkyl magnesium compounds, alkyl zinc compounds, alkyl lithium compounds, and mixtures of two or more thereof.

18. A process according to claim 17 wherein said non-hydrolyzed metal alkyl is an alkyl aluminum compound.

19. A process according to claim 18 wherein said alkyl aluminum compound is triethyl aluminum.

20. A process according to claim 13 wherein said pyrrole-containing compound is selected from the group consisting of pyrrole, derivatives of pyrrole, alkali metal pyrrolides, salts of alkali metal pyrrolides, and mixtures thereof.

21. A process according to claim 20 wherein said pyrrole-containing compound is selected from the group consisting of hydrogen pyrrolide, 2,5-dimethylpyrrole, and mixtures thereof.

22. A process according to claim 13 wherein said catalyst system further comprises a halide source.

23. A process according to claim 13 wherein said contacting occurs in the presence of an aromatic compound.

24. A process according to claim 23 wherein said aromatic hydrocarbon has less than about 70 carbon atoms per molecule.

25. A process to produce olefins comprising contacting one or more olefins with a catalyst system comprising a chromium source, a pyrrole-containing compound and a metal alkyl that has been prepared with stirring at a rate that reduces the production of solids.

26. A process according to claim 25 wherein said olefin is ethylene.

27. A process according to claim 25 wherein said contacting occurs in the presence of an aromatic compound.

28. A process according to claim 25 comprising trimerizing ethylene.

29. A process to produce olefins comprising contacting one or more olefins with a catalyst system comprising a chromium source, a pyrrole-containing compound and a metal alkyl that has been prepared with stirring at a rate that reduces the production of solids.

30. A process according to claim 29 wherein said olefin is ethylene.

31. A process according to claim 29 wherein said contacting occurs in the presence of an aromatic compound.

32. A process according to claim 29 comprising trimerizing ethylene.
